(19) United States
(12) Patent Application Publication
(10) Pub. No.: US 2008/0196770 A1
(43) Pub. Date: Aug. 21, 2008

(54) Valve for Automobile Bodies

(75) Inventors: Thomas Ruckel, Aub (DE); Frank Eckstein, Gibelstadt (DE)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ITW AUTOMOTIVE PRODUCTS GMBH & CO. KG, Iserlohn (DE)

(21) Appl. No.: 11/916,998

(22) PCT Filed: Jun. 14, 2006
(86) PCT No.: PCT/IB2006/001596

§ 371 Date: Dec. 9, 2007

(30) Foreign Application Priority Data
Jun. 14, 2005 (DE) 10 2005 027 282.7

(51) Int. Cl. B62D 25/00; F16K 15/00

(52) U.S. Cl. 137/354; 137/519

(57) ABSTRACT

A valve mounted in a circular aperture in an approximately horizontal automobile body part, comprising a valve body fitted with means that shall be in-stalled in sealing manner in said aperture, further a valve element that in its closed position cooperates in sealing manner with the said valve body and that in its open position allows water draining from top to bottom, characterized in that the valve element is rotationally symmetrical and designed in a manner that it shall float up at a water pressure underneath it and be adjusted thereby into the closed position and in that the valve element comprises a conical segment resting in sealing manner against the edge facing it of the cross-sectionally circular passage of the valve body.

### RELATED APPLICATIONS

The present application is based on, and claims priority from, German Application Number 10 2005 027 282.7, filed on 14 Jun. 2005, the disclosure of which is hereby incorporated by reference herein in its entirety.

### TECHNICAL FIELD

The present invention relates to valves for automobile bodies.

### BACKGROUND

Water may collect in low-lying automobile body parts. Accordingly collecting water must be allowed to drain. One approach is using a mere hole. On the other hand the water also must be prevented from moving from underneath to the top side of the automobile body part, where corrosion might then occur.

Valves already are known which allow sealing off the water while the automobile is operating. The water moreover can drain only when a given water pressure is exceeded. This design furthermore incurs the drawback that the valve body, i.e. the valve element, can be mounted only in a predetermined position, the valve itself consisting three individual parts.

### SUMMARY

The objective of the present invention is to create a valve allowing draining the water regardless of any defined water pressure and furthermore providing sealing against water independently of vehicle operation, this new valve design moreover being exceedingly simple.

As regards the valve of the present invention, its valve element is designed in a manner that it shall be buoyed up in the presence of water pressure and be moved into it dosed position. Said valve element comprises a conical segment which in its closed position rests in sealing manner against the opposite edge of the circular aperture or circular passage in said seat. This feature offers the advantage that, as regards the gravity-driven open position, the water shall drain in the absence of a defined water pressure. The valve element being rotationally symmetrical. It may be mounted in any rotational position. Also the present invention allows designing two-part valves, namely comprising the valve body configured in said aperture and said valve element.

In one embodiment mode of the present invention, the valve body is fitted underneath the passage with a further peripheral sealing edge or face which cooperates with another peripheral sealing edge or face of the valve element when latter is in its dosed position. Sealing is attained in this manner, that shall unfailingly prevent water passing from below through the passage to the automobile body top side.

In a further embodiment mode of the present invention, the valve body is fitted with an upper radial flange and with a lower radial flange configured a distance below, said two flanges when deformed resting against the facing side of the automobile body part when the valve body is moved into the open position.

In yet another embodiment mode of the present invention, the valve element is conical and hollow and comprises a radial, peripheral collar fitted with the sealing face. Preferably the hollow element is open downward and is reinforced mutually on the inside by diametrically configured braces or the like. Said braces moreover make it feasible to assemble the valve element by merely applying thumb pressure on them. The water moves from below into the cavity of the valve element and buoys up the said element and allows the element to come to rest against the valve body sealing faces.

In yet another embodiment mode of the present invention, the valve element is fitted with a head by means of which said element rests radially outside the passage in the valve body when it is in the open position. Preferably said head consists of radial arms which during valve element assembly can be deformed to pass through the passage in the valve body.

In a further embodiment mode of the present invention, the valve body comprises a cylindrical surface situated underneath the passage and the valve element is fitted at its conical surface with integrated protrusions having arcuate outer surface elements of which the radius is slightly less than the inside radius of the cylindrical surface.

### BRIEF DESCRIPTION OF THE DRAWINGS

The invention is elucidated below by means of an illustrative embodiment shown in the appended drawings.

FIG. 1 is a perspective of a valve body of a valve of the invention seen obliquely from above,

FIG. 2 is a perspective of the valve body of FIG. 1 seen from below,

FIG. 3 is a perspective of a valve element of the valve seen from above,

FIG. 4 is a perspective of the valve element of FIG. 3 seen obliquely from underneath,

FIG. 5 is the bottom view of the valve element of FIGS. 3 and 4,

FIG. 6 is the topview of the valve element of FIGS. 3 and 4,

FIG. 7 is a cross-section of the valve of the invention in the open position in a sheetmetal aperture, and

FIG. 8 shows the valve of FIG. 7 in the dosed position.

### DETAILED DESCRIPTION OF THE EMBODIMENTS

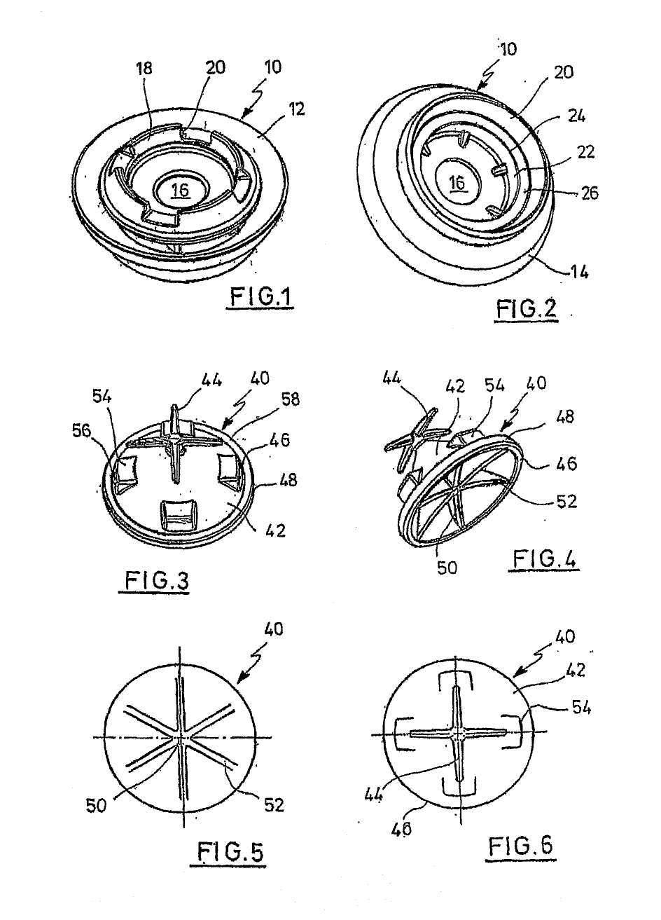

FIGS. 1 and 2 show a circular valve body 10 comprising an upper flange 12 and a lower flange 14. A circular passage 16 runs centrally through the valve body 10. An annular, axial, cross-sectionally triangular collar 18 runs above the flange 12 and radially away from this flange's outer edge, the collar 18 being interrupted by four rectangular cutouts 20 configured mutually 90° apart, though another number of such cutouts obviously may also be selected. The diameter of the lower flange 14 is larger and its radially external edge runs above the outer edge of the flange 12, as indicated in FIG. 8, before the valve body 10 has been mounted in place. An annular, axial and cross-sectionally triangular collar 20 exhibiting a lesser diameter than the flange 14 runs below same.

The valve body 10 is hollow and is fitted with a cylindrical guide surface 22 underneath the passage 16. A sealing edge 24 is subtended from the lower end of the said cylindrical guide surface. This sealing edge is formed by the radially Inner edge of a radial surface 26 which is adjoined by a conical surface 28. Be it borne in mind that all said parts and surfaces or edges are circular, the valve body 10 being manufactured to be rotationally symmetrical. However, non-symmetrical variations are not excluded.

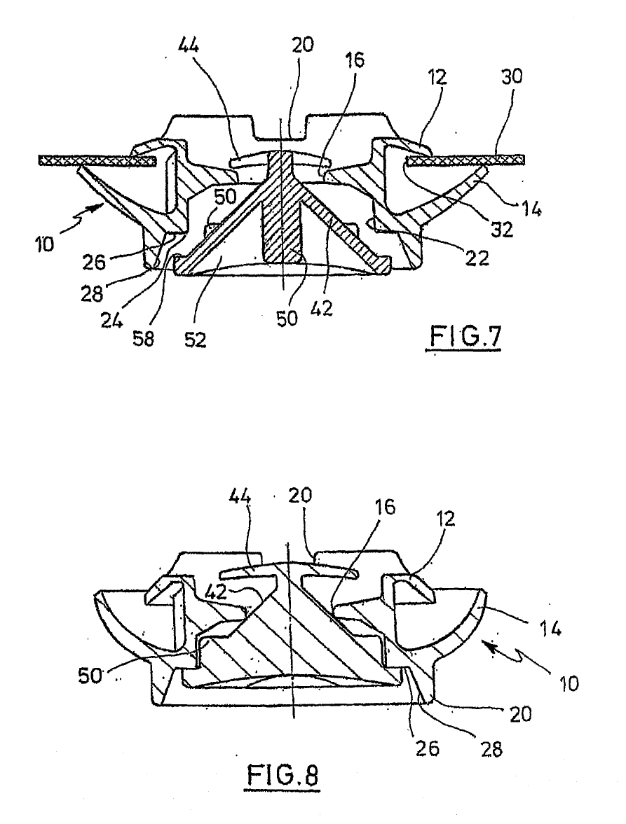

FIG. 7 shows a sheetmetal Illustratively part of an approximately horizontal automobile body part. The sheetmetal 30 comprises a circular aperture 32. FIG. 7 also shows the way the valve body 10 is mounted in the aperture 32. The annular-conical flange 12 rest against the top side, and the annular-conical flange 14 rest against the underside of the sheetmetal 30 in order to seal the aperture both from above and from below. When being installed, the valve body 10 is guided from below against the aperture 30 until the flange 12, thereby being deformed, can be inserted through said aperture. The expressions “from above” and “from below” herein mean that the upper sheetmetal surface is the top side and the lower sheetmetal surface is the side underneath. The same meaning applies to the orientation of the segments of the valve body 10.

FIGS. 3 through 6 show a valve element 40. Said element substantially is hollow and fitted with a conical cover 42 to the tip of which is integrated a cross of four coplanar arms 44 configured 90° apart, said common plane being orthogonal to the longitudinal axis of the valve element 40. A cylindrical ring 46 is subtended at the far end of the cover 42 and comprises a cylindrical external surface 48. The radius of the cylindrical surface 48 is larger than the radius of the sealing edge 24 of the valve body 10. A central post 50 is constituted within the cover 22 and is the origin of radially diametric braces 52. Said braces reinforce the cover 42.

Four protrusions 54 configured 90° apart and adjoining then circular segment 46 arise at the outside of the cover 42 and are fitted with an arcuate outer surface 56 of a lesser radius than the radius of the cylindrical surface 22 of the valve body 10. Another number of protrusions also may be used. Consequently the protrusions 54 provide guidance when moving the valve element 40 into the closed position shown in FIG. 8. In this closed position the sealing edge 24 rests against the top surface 58 of the ring 46 and thereby assures annular sealing thereby. Moreover the lower edge of the passage 16 rests against the outside of the cover 42 where it also assures sealing.

During assembly to said sheetmetal, the valve element 40 is inserted by its arms 44 through the passage 46, as a result of which, in the open position, the arms 44 brace the valve element 40 against the valve body 10. Water can drain unimpeded from the op side of the sheetmetal through the passage 16. When water pressure is applied form below, the valve element 40 will rise as shown in FIG. 8 and then implements the two sealing effects discussed above.

The valve element 40 and the valve body 10 may be made of different materials. Illustratively the valve body made be made of a somewhat softer plastic than the valve element 40.

1. A valve mounted in a circular aperture in an approximately horizontal automobile body part, comprising a valve body fitted with means that shall be installed in sealing manner in said aperture, further a valve element that in its closed position cooperates in sealing manner with the said valve body and that in its open position allows water draining from top to bottom,
characterized in that
the valve element is rotationally symmetrical and designed in a manner that it shall float up at a water pressure underneath it and be adjusted thereby into the closed position and in that the valve element comprises a conical segment resting in sealing manner against the edge facing it of the cross-sectionally circular passage of the valve body.

2. Valve as claimed in claim 1, characterized in that the valve body is fitted below the passage with a further sealing edge or sealing face cooperating with a peripheral sealing edge or face of the valve element when said element is in its closed position.

3. Valve as claimed in claim 1, characterized in that the valve body comprises an upper and a lower radial flange which while being deformed will rest against the sides facing them of the automobile body part when the valve body is mounted in the aperture.

4. Valve as claimed in claim 1, characterized in that the valve element is a conical hollow structure fitted with a radially peripheral collar into which is integrated a sealing face.

5. Valve as claimed in claim 1, characterized in that the cavity of the conical valve element is reinforced by diametrical braces.

6. Valve as claimed in claim 1, characterized in that the valve element is fitted with a head by means of which said element rests radially outside the passage, when it is in its open position, against the valve body.

7. Valve as claimed in claim 6, characterized in that the head comprises radially pointing arms.

8. Valve as claimed in claim 1, characterized in that the valve body is fitted with a cylindrical surface underneath the passage and in that the valve element comprises protrusions which are integrated into the conical surface and which have arcuate external guide surfaces, the radius of said guide surfaces being slightly less than the inside radius of the cylindrical surface.
